(19) United States
(12) Patent Application Publication
(10) Pub. No.: US 2014/0294072 A1
(43) Pub. Date: Oct. 2, 2014

(54) APPARATUSES AND METHODS FOR STAGGERED-FIELD INTRA-REFRESH

(71) Applicant: MAGNUM SEMICONDUCTOR, INC., Milpitas, CA (US)

(72) Inventor: Akrum Elkhazin, Waterloo (CA)

(73) Assignee: Magnum Semiconductor, Inc., Milpitas, CA (US)

(21) Appl. No.: 13/851,737

(22) Filed: Mar. 27, 2013

(51) Int. Cl. H04N 7/26

(52) U.S. Cl. CPC H04N 19/0003
USPC 375/240.12

(57) ABSTRACT

Examples of apparatuses and methods for performing staggered-field intra-refresh process are described herein. An example apparatus may include an encoder configured to provide an encoded bitstream based on a video signal. The encoder is configured to perform a staggered-field intra-refresh process over a series of frames of the video signal, where a frame of the series of frames is divided into a plurality of regions. The encoder includes an intra-refresh block configured to refresh a region of frame for a first field of the frame that is spatially offset from a region of the frame refreshed for a second field.

### TECHNICAL FIELD

Embodiments described relate to video encoding, and in particular to performing an intra-refresh operation.

### BACKGROUND

Modern block based video coding standards such as MPEG2, H.261, H.262, H.263 and H.264 take advantage of temporal and spatial redundancy to achieve efficient video compression. An intra-coded block or macroblock is coded based on predictions from neighboring macroblocks, whereas inter-coded macroblocks are coded based on temporal predictions. Video frames are typically organized using intra-frames (I-frames), containing all intra-coded macroblocks, with a series of inter-coded frames (P-frames) in between. P-frames cannot be properly decoded without first decoding one or more previous frames. I-frames are generally larger than P-frames, but are required for random access (e.g., a receiver capable of entering a video stream at any point, and to limit the propagation of transmission errors.

In latency constrained environments, the additional buffering required by intra frames can be reduced through the process of intra-refresh. Intra-refresh spatially divides the intra-frame into a set of regions, refreshes one region at a time over a series of frames, and restricts motion predictions for refreshed regions (e.g., clean regions) to prevent reconstructed pixels for the clean refreshed pixels to be predicted from pixels of a region yet to be refreshed (e.g., a dirty region). For a series of N frames, the intra-refresh process may include dividing the visible area into L=N regions {1 . . . L}. For the lth frame in the series, regions {1 . . . l} are marked as clean regions and regions {l+1 . . . L} are marked as dirty regions. During the intra-refresh process, coding using an intra-mode may be forced for all clean region macroblocks where a best inter-mode refers to a dirty region. The intra-refresh cycle may repeat periodically, similar to periodic intra-frames, such that after decoding a complete cycle of frames, a decoder can reconstruct the entire visual space thus eliminating the need for I-frames.

One drawback of intra-refresh is a beating or pulsing that is often seen on textured content when a region transitions from a dirty region to a clean region. Since only part of the video frame is refreshed with intra-macroblocks, intra-beating is more pronounced in intra-refresh systems than in conventional systems with intra-frames. Thus, mitigation and reduction of the negative visual side effects of intra-refresh for interlaced video is desired.

### BRIEF DESCRIPTION OF THE DRAWINGS

FIG. 1 is a block diagram of an encoding system with staggered-field intra-refresh;

FIG. 2 is a block diagram of an encoding system with staggered-field intra-refresh;

FIG. 3 is schematic block diagram of a predictive distortion filter according to an embodiment of the disclosure;

FIG. 4 is a block diagram of a particular illustrative embodiment of a staggered-field intra-refresh;

FIG. 5 is a flow diagram of a particular illustrative embodiment of a method of performing a staggered-field intra-refresh;

FIG. 6 is a schematic illustration of a media delivery system according to an embodiment of the invention; and

FIG. 7 is a schematic illustration of a video distribution system that may make use of encoders described herein.

### DETAILED DESCRIPTION

Certain details are set forth below to provide a sufficient understanding of embodiments of the disclosure. However, it will be clear to one having skill in the art that embodiments of the disclosure may be practiced without these particular details, or with additional or different details. Moreover, the particular embodiments described herein are provided by way of example and should not be used to limit the scope of the disclosure to these particular embodiments. In other instances, well-known video components, encoder or decoder components, circuits, control signals, timing protocols, and software operations have not been shown in detail in order to avoid unnecessarily obscuring the disclosure.

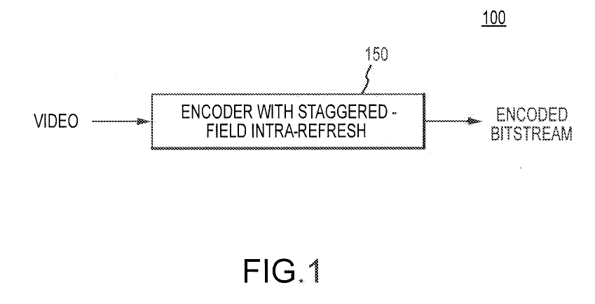

FIG. 1 is a block diagram of an encoding system 100 according to an embodiment of the disclosure. The encoding system 100, which may be implemented in hardware, software, firmware, or combinations thereof, may include an encoder 150 with joint rate-distortion optimization. The encoder 150 may include control logic, logic gates, processors, memory, and/or any combination or sub-combination of the same, and may be configured to encode and/or compress a video signal to produce a coded bit-stream signal using one or more encoding techniques, examples of which will be described further below.

The encoder 150 may be configured to perform a staggered-field intra-refresh on interlaced content. In encoding interlaced content, a first field and a second field of a frame may be encoded separately at different times. Thus, in an interlaced video implementation, data for the first field of a frame may be received at the encoder 150 at a first time and data for the second field of the frame may be received at the encoder 150 at a second time. In some embodiments, the first field may include even parity horizontal lines and the second field may include odd parity horizontal lines. During the staggered-field intra-refresh process, different regions of a frame are refreshed for the first field and the second field, such that the intra-refresh region of one field is staggered or offset, spatially, from the other field. The staggered-field intra-refresh is completed over a group of frames. Staggering the refresh regions for a field leads to changes in the intra-refresh region of one field being masked by the other field.

The encoder 150 may be implemented in any of a variety of devices employing video encoding, including, but not limited to, televisions, broadcast systems, mobile devices, and both laptop and desktop computers. In at least one embodiment, the encoder 150 may include an entropy encoder, such as a variable-length coding encoder (e.g., Huffman encoder, context-adaptive variable length coding (CAVLC) encoder, or context-adaptive binary arithmetic coding (CABAC) encoder), and/or may be configured to encode data, for instance, at a macroblock level. Each macroblock may be encoded in intra-coded mode, inter-coded mode, bidirectionally, or in any combination or subcombination of the same.

As an example, the encoder 150 may receive and encode a video signal that, in one embodiment, may include video data (e.g., frames). The video signal may be encoded in accordance with one or more encoding standards, such as MPEG-2, MPEG-4, H.263, H.264, and/or HEVC, to provide the encoded bitstream. The encoded bitstream may be provided to a data bus and/or to a device, such as a decoder or transcoder (not shown). As will be explained in more detail below, a video signal may be encoded by the encoder 150 using the staggered-field intra-refresh process such that an intra-refresh region of one field of a frame is staggered or offset, spatially, from another field of the frame. Selection of the one of a plurality of available coding modes may be based on optimizing a total cost of encoding a current macroblock using a particular prediction mode and, whether a current macroblock is in a region to be refreshed for an associated field. In some embodiments, a prediction distortion filter may be used to apply a degree of inter-predictive distortion to the source pixels before encoding. Staggering refresh regions for fields of the frame may reduce noticeable visual artifacts on a display as compared with an intra-refresh of an interlaced video signal on a common region of a frame for a first field and a second field.

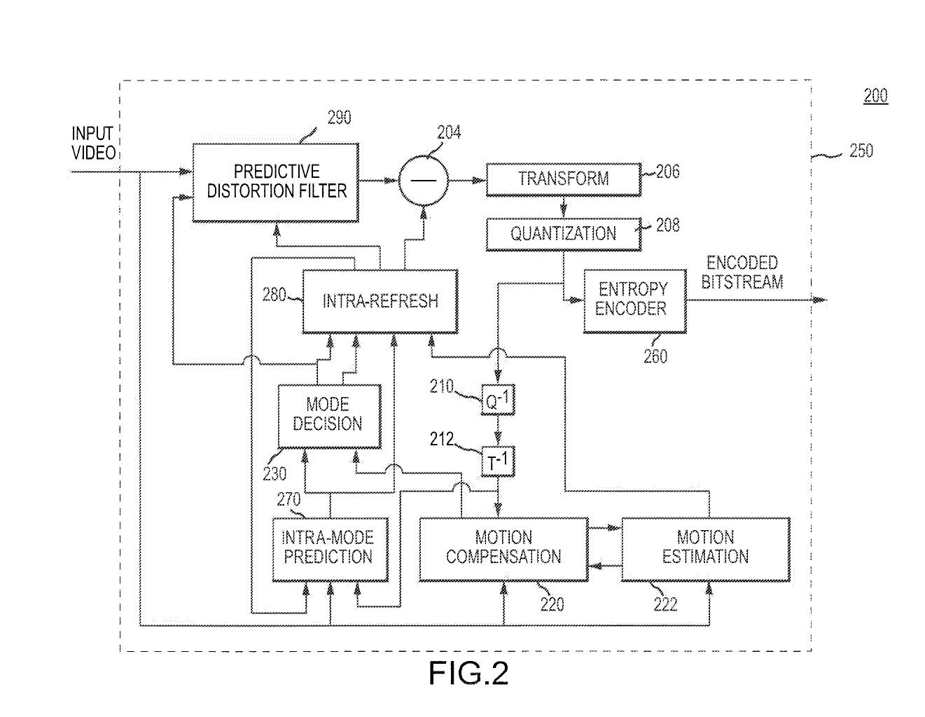

FIG. 2 is a block diagram of an encoding system 200 according to an embodiment of the disclosure. The encoding system 200 may include an encoder 250 used to implement the encoder 150 of FIG. 1, and may operate in accordance with one or more encoding standards in the art, known now or in the future. The encoder 250 may be implemented in semiconductor technology, and may be implemented in hardware, software, or combinations thereof. The encoder 250 may include an encoding path having a predictive distortion filter 290, an intra-refresh block 280, a mode decision block 230, a transform block 206, a quantizer 208, and an entropy encoder 260.

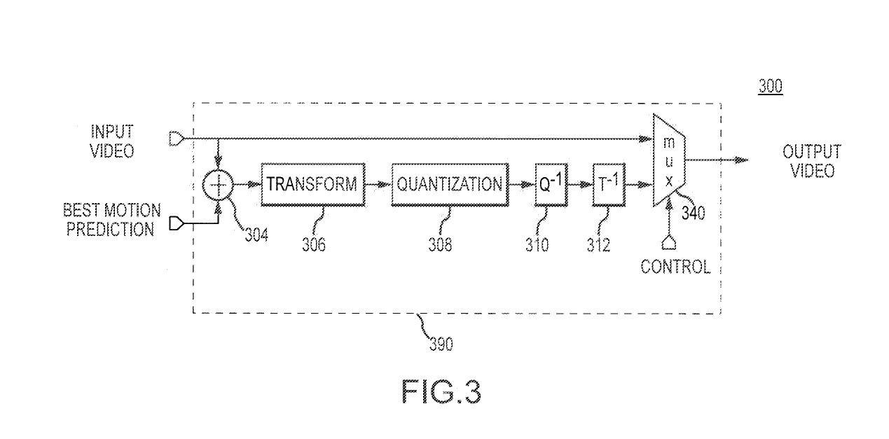

The predictive distortion filter 290 may be configured to receive the video signal and a best motion prediction from the mode decision block 230, and to provide, to a subtractor 204, an output signal based on a value of a control signal from an intra-refresh block 280. For example, while the control signal has a first value (e.g., a disabled value), the predictive distortion filter 290 may be configured to provide the video signal at the output. While the control signal has the second value (e.g., an enabled value), the predictive distortion filter 290 may be configured to provide a filtered video signal at the output that mixes the video signal and a best motion prediction received from the mode decision block 230. Operation of the predictive distortion filter 290 is described further with reference to FIG. 3. The filtered video signal provided by the predictive distortion filter 290 may pre-distort the source pixels of the video signal. Applying the predictive distortion filter 290 on macroblocks may mask visual artifacts of intra-refreshing on a portion of visual space of a frame. In some embodiments, the predictive distortion filter 290 may be omitted or replaced with a delay, and the video signal may be provided to the subtractor 204.

The mode decision block 230 may be configured to provide a best mode prediction and a prediction for the best mode prediction based on the best intra-mode prediction received from an intra-mode prediction block 270, and a best inter-mode prediction generated based on the motion compensated prediction received from the motion compensation block 220 and motion estimation block 222. In some embodiments the best mode prediction may be selected based on a rate distortion cost (e.g. λR+D, where R denotes the true bit cost of encoding the affected macroblock with a specified mode, D denotes the distortion calculated using a selected distortion metric and is a Lagrangian optimization parameter). In some embodiments, selection of a best mode prediction may also include a selection of a set of motion vectors (e.g., out of plurality of motion vectors provided by the motion estimation block 222) and/or one of a set of quantization parameters. The mode decision block 230 may also be configured to provide, to the predictive distortion filter 290, a best motion estimation based on the motion compensated prediction received from the motion compensation block 220 and motion estimation block 222.

The intra-refresh block 280 may be configured to receive the best mode prediction and the prediction for the best mode prediction from the mode decision block 230. The intra-refresh block 280 may also be configured to receive reference and motion vector information for inter-mode prediction from the motion compensation block 220 and/or the motion estimation block 222 for a given macroblock. The intra-refresh block 280 may be configured to select a predicted mode based on the inputs and based on whether the encoder 250 is performing a staggered-field intra-refresh process. Based on the selected predicted mode, the intra-refresh block 280 may be configured to provide a motion prediction signal to the subtractor 204, a control signal to the predictive distortion filter 290, and the prediction constraint information to the intra-mode prediction block 270 based on the inputs. The prediction constraint may include information related to the coding standard (e.g., H.264 information, MPEG-2 information) and/or a location of a macroblock to be code (e.g., whether the macroblock is along the boundary of a staggered-field intra-refresh region).

The subtractor 204 may be configured to receive a motion prediction signal from the intra-refresh block 280 and an output signal from the predictive distortion filter 290. The output of the subtractor 204 may be a residual, e.g. the difference between the output signal from the predictive distortion filter 290 and the motion prediction signal. The transform block 206 may be configured to perform a transform, such as a discrete cosine transform (DCT), on the residual received from the subtractor 204 to produce a set of blocks of coefficients (typically by processing the residual in blocks of 8×8 pixels or 4×4 pixels) that may, for instance, correspond to spectral components of data in the video signal. Generally, the transform block 206 may transform the residual to a frequency domain representation of the residual referred to as a set of coefficient blocks.

The quantization block 208 may be configured to receive the coefficient block and quantize the coefficients of the coefficient block to produce a quantized coefficient block. The quantization provided by the quantization block 208 may be lossy and/or may also utilize a weighting factor (lambda) to adjust and/or optimize rate-distortion tradeoff for one or more coefficients of the coefficient block. Lambda may be received from the mode decision block 230, may be specified by a user, or may be provided by another element of the encoder 250. Lambda may be adjusted for each macroblock or for any other unit, and may be based on information encoded by the encoder 250 (e.g., video signals encoding advertising may utilize a generally larger lambda or smaller lambda inverse than video signals encoding detailed scenes). Lambda may also be common to the mode decision block 230 and the quantization block 208 (i.e. the same parameter is used for rate-distortion optimization of the coding mode and rate-distortion optimization of the quantized coefficients).

The entropy encoder 260 may encode the quantized coefficient block with an encoding technique, such as CAVLC. The entropy encoder 260 may receive syntax elements (e.g., quantized coefficients, differential motion vectors, macroblock modes, etc.) from other devices of the macroblock encoder 250, such as the quantization block 208, the motion compensation block 220, the motion estimation block 222, and/or the intra prediction block 270. The entropy encoder 260 may be any entropy encoder known by those having ordinary skill in the art or hereafter developed, such as a variable length coding (VLC) encoder or a binary arithmetic coding encoder (e.g. CABAC).

As discussed, in some embodiments, the encoder 250 may operate in accordance with the MPEG-2 video coding standard and the H.264 video coding standard. Thus, because the MPEG-2 and the H.264 video coding standards employ motion prediction and/or compensation, the encoder 250 may further include a feedback path that includes an inverse quantizer 210 and an inverse transform 212. These elements may mirror elements included in a decoder (not shown) that is configured to reverse, at least in part, the encoding process performed by the encoder 250. Additionally, the feedback loop of the encoder 250 may include the intra-mode prediction block 270, the motion compensation block 220, and the motion estimation block 222.

The quantized coefficient block may be inverse quantized by the inverse quantizer (Q⁻¹) 210 to provide recovered coefficients, and the recovered coefficients for a macroblock may be inverse transformed by the inverse transform (T⁻¹) 212 to produce a reconstructed macroblock residual. The reconstructed residual may be provided to the intra-mode prediction block 270 and the motion compensation block 220 for use in macroblock intra-mode prediction and/or inter-mode prediction mode decision methodologies.

The intra-mode prediction block 270 is configured to provide a best intra-mode prediction to a mode decision block 230. The best intra-mode prediction may be determined from source pixels of the frame, neighboring reconstructed pixels from previously encoded macroblocks, and/or constraints on predicted modes imposed by a staggered-field intra-refresh process received from the intra-refresh block 280. Coding modes may be applied on a per-frame, per-region, and/or per-macroblock basis. A motion compensation block 220 and a motion estimation block 222 may work together to provide the motion compensated prediction for one or more reference frames to the mode decision block 230. In some embodiments, motion compensation block 220 and a motion estimation block 222 may provide predicted motion vectors and references for predictions (e.g., a frame, a macroblock, etc.).

In an example operation of the encoder 250, a video signal (e.g., a base band video signal) may be provided to the encoder 250. The video signal may be provided to the prediction distortion filter 290, the intra-mode prediction block 270, the motion compensation block 220, and the motion estimation block 222. The predictive distortion filter 290 may be configured to provide the video signal or a filtered video signal to the subtractor 204 based on a value of a control signal received from the intra-refresh block 280. The subtractor 204 may be configured to subtract the video signal or the filtered video signal from a motion prediction signal received from the intra-refresh block 280 to generate a residual. The residual may be provided to the transform block 206 and processed using a forward transform, such as a DCT. The transform block 206 may generate a coefficient block that may be provided to the quantizer 208, and the quantizer 208 may quantize the coefficient block. Quantized coefficients and other syntax elements may be provided to the entropy encoder 260 and encoded into an encoded bitstream.

As explained above, the block of quantized coefficients may be inverse quantized, inverse transformed, and added to the motion prediction signal by the inverse quantization block 210 and, the inverse transform 212, respectively, to produce a reconstructed video signal. Both the motion compensation block 220 and the intra-mode prediction block 270 may be configured to receive the reconstructed video signal. Based on the reconstructed video signals, the intra-mode prediction block 270 may provide best intra-mode prediction to the mode decision block 230 and to the intra-refresh block 280. Further, as explained above, based on the reconstructed video signals, the motion compensation block 220 and the motion estimation block 222 may work together to provide a motion compensated prediction for one or more reference frames to the mode decision block 230 and to the intra-refresh block 280. The mode decision block 230 provides a best mode prediction and a prediction for the best mode prediction to the intra-refresh block 280.

As explained with reference to FIG. 1, the encoder 250 may be configured to encode an interlaced video input, which may include encoding a first field of a frame separate from a second field of the frame. The first field may be received at the encoder 250 at a different time than the second field. In some embodiments, the first field may include even parity horizontal lines and the second field may include odd parity horizontal lines.

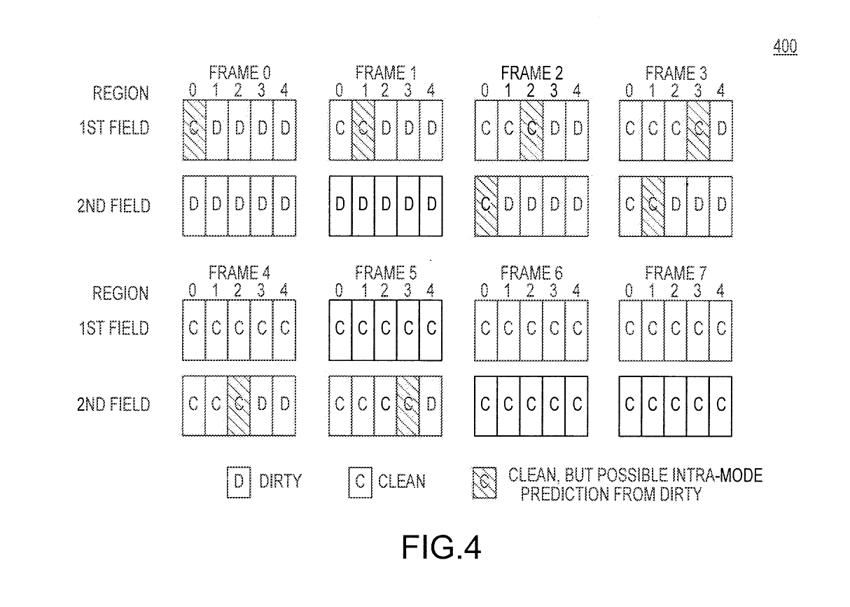

At a frame level, the intra-refresh block 280 may be configured to manage a staggered-field intra-refresh process over a series of frames, and, for each macroblock, to provide a predicted mode to the subtractor 204. In an example, for a series of N frames, the intra-refresh process may include dividing each frame of the series of frames into L regions {1 . . . L}. In the staggered-field intra-refresh process, L may be less than N. During the staggered-field intra-refresh process, the intra-refresh block 280 may be configured to perform a refresh on different regions for each of the first field and the second field, such that the first field and the second field refresh different regions (e.g., are spatially offset) of a given frame of the series of frames. In an example staggered-field intra-refresh process, a region mapping strategy may include offsetting (e.g., spatially) the second field intra-refresh region map from the first field map by a fixed number of frames. FIG. 4 depicts an example of a staggered-field intra-fresh process over a series of frames. As each frame is processed, the intra-refresh block 280 is configured to maintain respective previously refreshed regions as clean regions, and respective regions yet to be refreshed for a field as dirty regions for each field.

At a macroblock level, in processing of each macroblock to be coded during a staggered-field intra-refresh process, the intra-refresh block 280 may be configured to select a predicted mode based on a location of the macroblock in the field of the frame, a best mode prediction and a prediction for the best mode prediction received from the mode decision block 230, and the reference and motion vector information for inter-predicted references from the motion estimation block 222. The predicted mode may be selected from the best mode prediction received from the mode decision block 230 or the best intra-mode prediction from the intra-mode prediction block 270.

For example, for a current macroblock if the best mode prediction is an intra-mode prediction or the current macroblock is in a dirty region, then the best mode prediction received from the mode decision block 230 may be selected. Further, the best mode prediction received from the mode decision block 230 may also be selected if the current macroblock is in a clean region and a best mode prediction is an inter-mode prediction with all predictions based on references from clean regions. Based on the best mode prediction from the mode decision block 230 being selected, the intra-refresh block 280 may be configured to provide a motion prediction signal associated with the best mode prediction to the subtractor 204 and, in some examples, the control signal having a first value to the predictive distortion filter 290. As explained above, based on the control signal having the first value, the predictive distortion filter 290 may be configured to provide the video signal to the subtractor 204.

If the current macroblock is in a clean region and a best mode prediction is an inter-mode prediction with at least one prediction based on a reference from a dirty region, the intra-refresh block 280 may be configured to override the best mode prediction from the mode decision block 230, and select the best intra-mode prediction from the intra-mode prediction block 270. Based on selection of the best intra-mode prediction from the intra-mode prediction block 270, the intra-refresh block 280 may be configured to provide a motion prediction signal to the subtractor 204 based on the best intra-mode prediction and, in some examples, the control signal having the second value to the predictive distortion filter 290. As explained above, based on the control signal having the second value, the predictive distortion filter 290 may be configured to provide a filtered video signal to the subtractor 204.

The above example operation is provided for illustrative purposes, and is not intended to limit the disclosure. One having ordinary skill in the art would recognize that encoding of macroblocks may include other dependencies. Using the staggered-field intra-refresh process may mask visual artifacts stemming from intra-refreshing different regions of visible space at different times.

FIG. 3 is a block diagram of an apparatus including an exemplary embodiment of a predictive distortion filter 390 according to an embodiment of the disclosure. The predictive distortion filter 390 may correspond to the predictive distortion filter 290 of FIG. 2. The predictive distortion filter 390 may be configured to pre-distort the source pixels of macroblocks that are forced to use the best intra-mode prediction. When enabled, the predictive distortion filter 390 may be configured to mix the source pixels from the video signal with inter-predicted pixels from a best motion prediction signal by forward and inverse transforming/quantizing the inter-frame prediction. In some embodiments, the predictive distortion filter 390 may forward and inverse transform/quantize the inter-frame prediction at a quality level relatively higher than that used to encode the frame. Applying the predictive coding filter 390 on macroblocks that are forced to be coded using an intra-mode prediction due to the staggered-field intra-refresh process may mask visual artifacts of intra-refreshing on at least a part of visual space of a frame.

The predictive coding filter 390 may include a multiplexer 340 configured to receive a video signal a first input, and a filtered video signal at a second input. The multiplexer may be configured to provide one of the video signal or the filtered video signal at an output based on a value of a control signal. For example, while a control signal has a first value, the predictive distortion filter 390 may be disabled, and, thus, the multiplexer 340 may be configured to provide the video signal at the output. While a control signal has a second value, the predictive distortion filter 390 may be enabled, and, thus, the multiplexer 340 may be configured to provide the filtered video signal at the output.

To generate the filtered video signal, the predictive coding filter 390 may further include an adder 304, a transform block 306, a quantization block 308, an inverse quantizer (Q⁻¹) 310, and an inverse transform (T⁻¹) 312. The adder 304 may be configured to compensate source pixels of the video signal by adding a best motion prediction to produce a compensated video signal. In some embodiments, the best motion prediction may be received from a mode decision block of an encoder, such as the mode decision block 230 of FIG. 2.

Similar to the transform block 206 of FIG. 2, the transform block 306 may be configured to perform a transform, such as a discrete cosine transform (DCT), on the compensated video signal received from the adder 304 to produce a set of blocks of coefficients that may correspond to spectral components of data in the video signal. Generally, the transform block 306 may transform the compensated video signal to a frequency domain representation of the compensated video signal referred to as a set of coefficient blocks.

Similar to the quantization block 208 of FIG. 2, the quantization block 308 may be configured to receive the coefficient block and quantize the coefficients of the coefficient block to produce a quantized coefficient block. The quantization provided by the quantization block 308 a weighting factor (lambda) to adjust and/or optimize rate-distortion tradeoff for one or more coefficients of the coefficient block. In some embodiments, in order to produce a higher quality inter-frame prediction than used to encode the video signal in the encoder 250 of FIG. 2, the lambda used by the quantization block 308 may be smaller than the lambda used by the quantization block 208 of FIG. 2. In other embodiments, the lambda used by the quantization block 308 may be equal to the lambda used by the quantization block 208 of FIG. 2.

The quantized coefficient block may be inverse quantized by the inverse quantizer (Q⁻¹) 310 to provide recovered coefficients, and the recovered coefficients for a macroblock may be inverse transformed by the inverse transform (T⁻¹) 312 to produce the filtered video signal. The filtered video signal may be provided to the second input of the multiplexer 340.

As explained, the predictive distortion filter 390 may provide the filtered video signal to an output of the multiplexer 340 when the control signal has the second value. The control signal may be provided from an intra-refresh block, such as the intra-refresh block 280 of FIG. 2. In some embodiments, the intra-refresh block may provide the control signal having the first value responsive to selecting the best mode prediction from the mode decision block, and may provide the control having the second value when forcing the best intra-mode prediction.

FIG. 4 is a block diagram depicting an exemplary embodiment of a staggered-field intra-refresh process over a series of frames according to an embodiment of the disclosure. As depicted in FIG. 4, the intra-refresh process is conducted over a total of 8 frames (e.g., Frame 0 to Frame 7). Each frame is divided into a first field and a second field at the source, transmitted to an encoder (e.g., the encoder 150 of FIG. 1 and/or the encoder 250 of FIG. 2) at different times. In some embodiments, the first field may include even parity horizontal lines and the second field may include odd parity horizontal lines. Additionally, each frame is divided into five regions 0-4.

The staggered-field intra-refresh process may begin with processing data of frame 0. As depicted, region 0 of frame 0 for the first field is refreshed and indicated as a clean region (C), while remaining regions of frame 0 for the first field may be indicated as dirty regions (D). In order to spatially stagger or offset intra-refreshing regions of a frame for the first field and the second field (e.g., prevent the first field and the second field from refreshing the same region of a frame), none of the regions of the second field of frame 0 are refreshed. Thus, the regions 0-4 of frame 0 for the second field remain un-refreshed and indicated as dirty regions (D). For a clean region (C), each macroblock coded in the region is coded using a best mode prediction from a mode decision block, such as the mode decision block 230 of FIG. 2, unless the best mode prediction is an inter-mode prediction that has a prediction based on a reference from a dirty region (D). This may prevent a clean region (C) from becoming “contaminated” by basing a prediction on data from a dirty region (D). For a dirty region (D), each macroblock may be coded using a best mode prediction from the mode decision block. During the intra-refresh of the region 0 of frame 0 for the first field, a best intra-mode prediction for one or more macroblocks may be based on information from a dirty region (D) (e.g., indicated by the shading).

The staggered-field intra-refresh process continues with processing of frame 1. Region 1 of frame 1 for the first field is refreshed and indicated as a clean region (C). Region 0 of frame 1 continues to be maintained as a clean region (C) by avoiding encoding with a mode having a prediction based on a reference from a dirty region (D). The remaining regions 2-4 may remain dirty regions (D). Region 1 of frame 1 for the first field may include one or more macroblocks that have a best intra-mode prediction based on information from a dirty region (D) (e.g., indicated by the shading). Regions 0-4 of frame 1 of the second field remain un-refreshed, as indicated by the dirty region (D).

Processing of the frame 2, is similar to processing of frames 0 and 1, with region 2 of the frame 2 for the first field being refreshed and indicated as a clean region (C). Additionally, the second field begins refreshing, in particular, region 0 of frame 2 of the second field is refreshed, and indicated as a clean region (C). Thus, different regions for the first field (region 2) and the second field (region 0) are refreshed in frame 2, with a spatial offset of two regions. Regions 0 and 1 of the first field of frame 2 may continue to be maintained as clean regions (C). Regions 3-4 for the first field and regions 2-4 for the second field continue to be dirty regions (D).

The staggered-field intra-refresh process continues with processing of frames 3-6 in a similar manner as processing of frames 0-2 (e.g., and maintaining the intra-refresh spatial offset of the frame between the first field and the second field), with each field sequentially refreshing regions (e.g., regions 3 and 4 for the first field are refreshed in frames 3 and 4, respectively, and refreshing regions 1-4 for the second field are refreshed in frames 3-6, respectively). At frame 7, every region 0-4 of both of the first field and the second field are refreshed, and the staggered-field intra-refresh process is complete. In some embodiments, an encoder may start the staggered-field intra-refresh process again with frame 8. In other embodiments, the encoder may send one or more predictive frames (P-frames) before starting the staggered-field intra-refresh process again.

It will be appreciated that the staggered-field intra-refresh depicted in FIG. 4 is for illustrative purposes, and the staggered-field intra-refresh process can be conducted over any, number of frames, and each frame may be divided into any number of regions. Further, it will be appreciated that, while the spatial offset between the first field and the second field depicted in FIG. 4 is two regions, the spatial offset between the first field and the second field may be one region, or more than two regions in other embodiments.

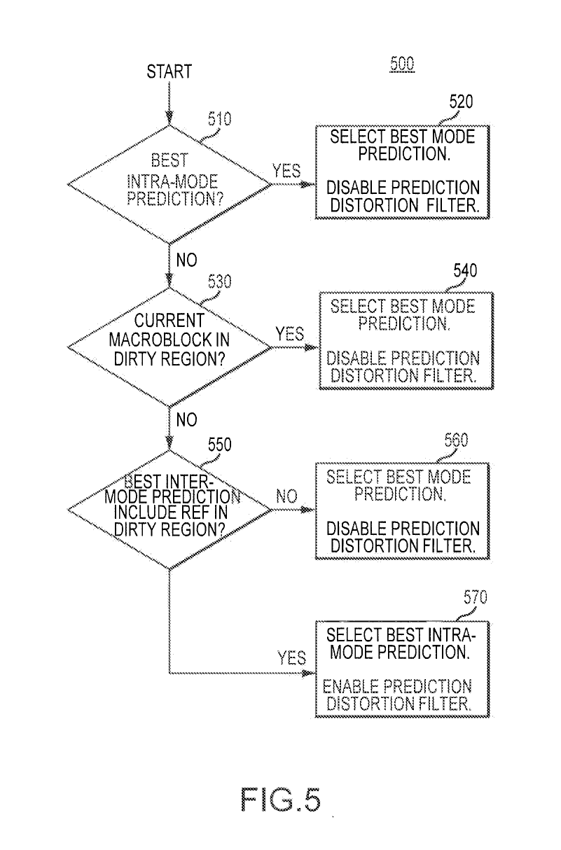

FIG. 5 is a flowchart 500 for a method for determining a coding mode of a current macroblock while undergoing a staggered-field intra-refresh process according to an embodiment of the disclosure. The method illustrated by the flowchart 500 may be implemented by the encoder 150 of FIG. 1, the encoder 250 of FIG. 2, or any combination thereof. In some embodiments, the method 500 may be performed at the intra-refresh block 280 of FIG. 2.

The method 500 may include determining whether a best mode prediction is an intra-mode prediction, at 510. The best mode prediction may be received from a mode decision block, such as the mode decision block 230 of FIG. 2. Responsive to the best mode prediction indicating an intra-mode prediction, the best mode prediction may be selected to code the current macroblock at the encoder, at 520. In encoders that include a predictive distortion filter, such as the predictive distortion filter 290 of FIG. 2 and/or the predictive distortion filter 390 of FIG. 3, the predictive distortion filter may be disabled (e.g., via a control signal having a second value) responsive to the best mode prediction indicating an intra-mode prediction, at 520. Responsive to the predictive distortion filter being disabled, the video signal may be provided at an output of the predictive distortion filter.

The method 500 may include, responsive to the best mode prediction indicating an inter-mode prediction, determining whether the current macroblock is in a dirty region (e.g., a region yet to be intra-refreshed), at 530. Responsive to the current macroblock being in a dirty region, the best mode prediction may be selected to code the current macroblock at the encoder, at 540. In encoders that include the predictive distortion filter, the predictive distortion filter may be disabled (e.g., via a control signal having a second value) responsive to the current macroblock being in a dirty region, at 540.

The method 500 may include, responsive to the current macroblock being in a clean region (e.g., not in a dirty region), determining whether a best inter-mode prediction includes a prediction based on a reference in a dirty region (e.g., a region yet to be refreshed), at 550. Responsive to the best inter-mode prediction including prediction based on references in clean regions only (e.g., no references from a dirty region), the best mode prediction may be selected to code the current macroblock at the encoder, at 560. In encoders that include the predictive distortion filter, the predictive distortion filter may be disabled (e.g., via a control signal having a second value) responsive to the best inter-mode prediction including prediction based on references in, clean regions only, at 560.

Responsive to the best inter-mode prediction including a prediction based on a reference in a dirty region, the best intra-mode prediction may be selected to code the macroblock at the encoder, at 570. In encoders that include the predictive distortion filter, the predictive distortion filter may be enabled (e.g., via a control signal having a first value) the best inter-mode prediction including a prediction based on a reference in a dirty region, at 570. Responsive to the predictive distortion filter being enabled, a filtered video signal may be provided at an output of the predictive distortion filter.

The method 500 may be implemented by a field-programmable gate array (FPGA) device, an application-specific integrated circuit (ASIC), a processing unit such as a central processing unit (CPU), a digital signal processor (DSP), a controller, another hardware device, a firmware device, or any combination thereof. As an example, the method 500 of be implemented by a computing system using, for example, one or more processing units that may execute instructions for performing the method that may be encoded on a computer readable medium. The processing units may be implemented using, e.g. processors or other circuitry capable of processing (e.g. one or more controllers or other circuitry). The computer readable medium may be transitory or non-transitory and may be implemented, for example, using any suitable electronic memory, including but not limited to, system memory, flash memory, solid state drives, hard disk drives, etc. One or more processing units and computer readable mediums encoding executable instructions be used to implement all or portions of encoders or encoding systems described herein.

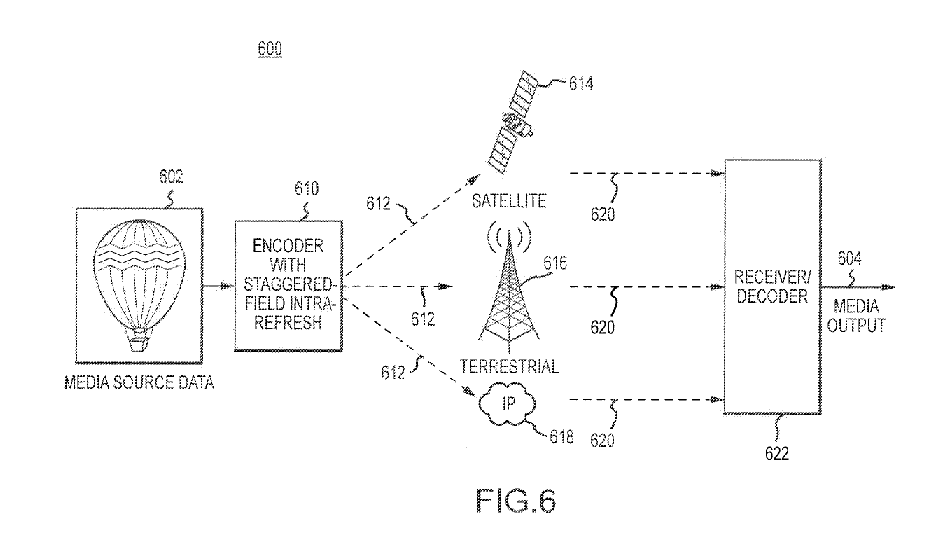

FIG. 6 is a schematic illustration of a media delivery system in accordance with embodiments. The media delivery system 600 may provide a mechanism for delivering a media source 602 to one or more of a variety of media output(s) 604. Although only one media source 602 and media output 604 are illustrated in FIG. 6, it is to be understood that any number may be used, and examples may be used to broadcast and/or otherwise deliver media content to any number of media outputs.

The media source data 602 may be any source of media content, including but not limited to, video, audio, data, or combinations thereof. The media source data 602 may be, for example, audio and/or video data that may be captured using a camera, microphone, and/or other capturing devices, or may be generated or provided by a processing device.

Media source data 602 may be analog or digital. When the media source data 602 is analog data, the media source data 602 may be converted to digital data using, for example, an analog-to-digital converter (ADC). Typically, to transmit the media source data 602, some type of compression and/or encryption may be desirable. Accordingly an encoder 610 with staggered-field intra-refresh may be provided that may encode the media source data 602 using any encoding method in the art, known now or in the future, including encoding methods in accordance with video standards such as, but not limited to, MPEG-2, MPEG-4, H.264, HEVC, or combinations of these or other encoding standards. The encoder 610 with staggered-field intra-refresh may be implemented using any encoder according to an embodiment of the invention, including the encoder 150 of FIG. 1 and the encoder 250 of FIG. 2, and further may be used to implement the method 500 of FIG. 5.

The encoded data 612 may be provided to a communications link, such as a satellite 614, an antenna 616, and/or a network 618. The network 618 may be wired or wireless, and further may communicate using electrical and/or optical transmission. The antenna 616 may be a terrestrial antenna, and may, for example, receive and transmit conventional AM and FM signals, satellite signals, or other signals known in the art. The communications link may broadcast the encoded data 612, and in some examples may alter the encoded data 612 and broadcast the altered encoded data 612 (e.g., by re-encoding, adding to, or subtracting from the encoded data 612). The encoded data 620 provided from the communications link may be received by a receiver 622 that may include or be coupled to a decoder. The decoder may decode the encoded data 620 to provide one or more media outputs, with the media output 604 shown in FIG. 6.

The receiver 622 may be included in or in communication with any number of devices, including but not limited to a modem, router, server, set-top box, laptop, desktop, computer, tablet, mobile phone, etc.

The media delivery system 600 of FIG. 6 and/or the encoder with staggered-field intra-refresh 610 may be utilized in a variety of segments of a content distribution industry.

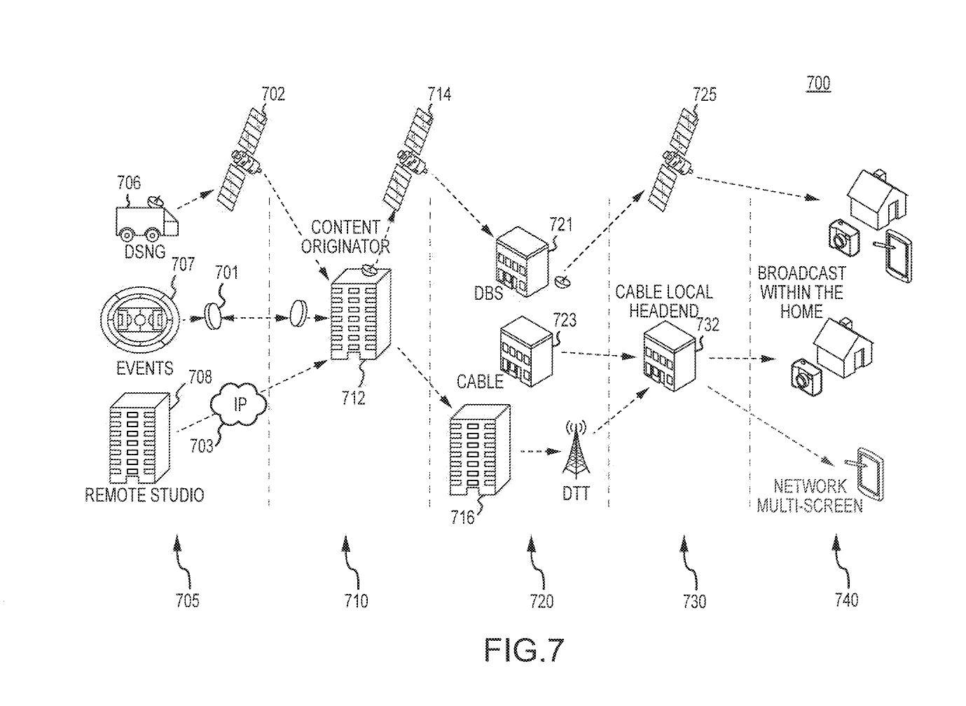

FIG. 7 is a schematic illustration of a video distribution system that 700 may make use of encoders described herein. The video distribution system 700 includes video contributors 705. The video contributors 705 may include, but are not limited to, digital satellite news gathering systems 706, event broadcasts 707, and remote studios 708. Each or any of these video contributors 705 may utilize an encoder described herein, such as the encoder with staggered-field intra-refresh 610 of FIG. 6, to encode media source data and provide encoded data to a communications link. The digital satellite news gathering system 706 may provide encoded data to a satellite 702. The event broadcast 707 may provide encoded data to an antenna 701. The remote studio 708 may provide encoded data over a network 703.

A production segment 710 may include a content originator 712. The content originator 712 may receive encoded data from any or combinations of the video contributors 705. The content originator 712 may make the received content available, and may edit, combine, and/or manipulate any of the received content to make the content available. The content originator 712 may utilize encoders described herein, such as the encoder with staggered-field intra-refresh 610 of FIG. 6, to provide encoded data to the satellite 714 (or another communications link). The content originator 712 may provide encoded data to a digital terrestrial television system 716 over a network or other communication link. In some examples, the content originator 712 may utilize a decoder to decode the content received from the contributor(s) 705. The content originator 712 may then re-encode data; potentially utilizing encoders described herein, such as the encoder with staggered-field intra-refresh 610 of FIG. 6, and provide the encoded data to the satellite 714. In other examples, the content originator 712 may not decode the received data, and may utilize a transcoder (which may consist of an encoder with staggered-field intra-refresh 610 of FIG. 6) to change an encoding format of the received data.

A primary distribution segment 720 may include a digital broadcast system 721, the digital terrestrial television system 716, and/or a cable system 723. The digital broadcasting system 721 may include a receiver, such as the receiver 622 described with reference to FIG. 6, to receive encoded data from the satellite 714. The digital terrestrial television system 716 may include a receiver, such as the receiver 622 described with reference to FIG. 6, to receive encoded data from the content originator 712. The cable system 723 may host its own content which may or may not have been received from the production segment 710 and/or the contributor segment 705. For example, the cable system 723 may provide its own media source data 602 as that which was described with reference to FIG. 6.

The digital broadcast system 721 may include an encoder, such as the encoder with staggered-field intra-refresh 610 described with reference to FIG. 6, to provide encoded data to the satellite 725. The cable system 723 may include an encoder, such as the encoder with staggered-field intra-refresh 610 described with reference to FIG. 5, to provide encoded data over a network or other communications link to a cable local headend 732. A secondary distribution segment 730 may include, for example, the satellite 725 and/or the cable local headend 732.

The cable local headend 732 may include an encoder, such as the encoder with staggered-field intra-refresh 610 as described with reference to FIG. 6, to provide encoded data to clients in a client segment 540 over a network or other communications, link. The satellite 725 may broadcast signals to clients in the client segment 740. The client segment 740 may include any number of devices that may include receivers, such as, the receiver 622 and associated decoder described with reference to FIG. 6, for decoding content, and ultimately, making content available to users. The client rsegment 740 may include devices such as set-top boxes, tablets, computers, servers, laptops, desktops, cell phones, etc.

Accordingly, encoding, transcoding, and/or decoding may be utilized at any of a number of points in a video distribution system. Embodiments may find use within any, or in some examples all, of these segments.

From the foregoing it will be appreciated that, although specific embodiments of the disclosure have been described herein for purposes of illustration, various modifications may be made without deviating from the spirit and scope of the disclosure. Accordingly, the disclosure is not limited except as by the appended claims.

What is claimed is:

1. An apparatus, comprising:
an encoder configured to provide an encoded bitstream based on a video signal, the encoder configured to perform a staggered-field intra-refresh process over a series of frames of the video signal, wherein a frame of the series of frames is divided into a plurality of regions, wherein the encoder comprises an intra-refresh block configured to refresh a region of the frame for a first field of the frame that is spatially offset from a region of the frame refreshed for a second field.

2. The apparatus of claim 1, wherein the first field comprises even parity lines of the frame, and wherein the second field comprises odd parity lines of the field.

3. The apparatus of claim 1, wherein the intra-refresh block is configured to refresh each region of the plurality of regions over the series of frames for the first field and for the second field.

4. The apparatus of claim 1, wherein the intra-refresh block is further configured to, over the series of frames, maintain regions of the plurality of regions for the first field that have been refreshed as clean regions and to maintain regions of the plurality of regions for the first field that have yet to be refreshed as dirty regions, and wherein the intra-refresh block is further configured to, over the series of frames, maintain regions of the plurality of regions for the second field that have been being refreshed as clean regions and to maintain regions of the plurality of regions for the second field that have yet to be refreshed as dirty regions.

5. The apparatus of claim 4, wherein the frame of the series of frames comprises a plurality of macroblocks, wherein the intra-refresh block is configured to encode a macroblock of the plurality of macroblocks based on a coding mode selected from a mode prediction from a mode decision block and an intra-mode prediction from an intra-mode prediction block.

6. The apparatus of claim 5, wherein the intra-refresh block is configured to select the mode prediction when at least one of:
the mode prediction is an intra-mode prediction;
the macroblock is in a dirty region; or
the mode prediction in an inter-mode prediction with all prediction references in clean regions.

7. The apparatus of claim 5, wherein the intra-refresh block is configured to select the intra-mode prediction when the macroblock is in a clean region and the mode prediction is an inter-mode prediction with at least one prediction reference from a dirty region.

8. The apparatus of claim 7, wherein the intra-refresh block is configured to enable a prediction distortion filter responsive to selecting the intra-mode prediction.

9. The apparatus of claim 5, wherein the encoder further comprises a mode decision block configured to provide the mode prediction based on a coding cost associated with the intra-mode prediction and an inter-mode prediction generated from a motion compensated prediction.

10. The apparatus of claim 1, wherein the encoder further comprises a prediction distortion filter configured to provide the video signal or a filtered video signal for encoding based on a control signal.

11. The apparatus of claim 10, wherein prediction distortion filter is configured to generate the filtered video signal based on a combined signal, wherein the combined signal includes a combination of the video signal and a motion prediction.

12. The apparatus of claim 10, wherein the prediction distortion filter comprises:
a transform block configured to perform a transform on the combined signal to generate a block of coefficients;
a quantization block configured to quantize the block of coefficients based on a weighting factor to produce a quantized block of coefficients;
an inverse quantizer configured to provide a reproduced block of coefficients based on the quantized block of coefficients; and
an inverse transform configured to generate the filtered video signal based on the reproduced block of coefficients.

13. A non-transitory computer-readable medium comprising instructions that, when executed by one or more processing units, cause the one or more processing units to:
select a first region of a frame to refresh for a first field;
select a second region of the frame to refresh for a second field, wherein the second region of the frame is spatially offset from the first region of the frame;
refresh the first region for the first field and the second region for the second field.

14. The non-transitory computer-readable medium of claim 13, further comprising instructions that, when executed by the one or more processing units, cause the one or more processing units to:
encode the first field including the refreshed first region; and
encode the second field including the refreshed second region.

15. The non-transitory computer-readable medium of claim 13, wherein instructions that, when executed by one or more processing units, cause the one or more processing units to refresh the first region for the first field and the second region for the second field comprises instructions that, when executed by the one or more processing units, cause the one or more processing units to select a coding mode for a macroblock of a frame based on a location in the frame and based on a prediction of a received mode prediction.

16. The non-transitory computer-readable medium of claim 13, wherein instructions that, when executed by one or more processing units, cause the one or more processing units to refresh the first region for the first field and the second region for the second field instructions that, when executed by the one or more processing units, cause the one or more processing units to enable a prediction distortion filter based on the selected coding mode.

17. A method, comprising:
refreshing, for a first field, a first region of a frame of a video signal; and
refreshing, for a second field, a second region of the frame of the video signal, wherein the frame comprises a combination of the first field and the second field, wherein the second region of the frame is spatially offset from the first region of the frame.

18. The method of claim 17, wherein refreshing for the first field and the second field comprises selecting a coding mode for a macroblock of the frame from a mode prediction and an intra-mode prediction.

19. The method of claim 18, wherein selecting a coding mode for a macroblock of the frame from the mode prediction or the intra-mode prediction comprises:
determining whether the mode prediction is an intra-mode prediction;
determining whether the mode prediction is an inter-mode prediction based on a reference in an un-refreshed region; and
determining whether the macroblock is in the first region and the first field or whether the macroblock is in the second region and the second field.

20. The method of claim 18, wherein selecting a coding mode for a macroblock of the frame from one of the mode prediction and the intra-mode prediction further comprises selecting the intra-mode prediction when:
the macroblock is in the first region and the first field or the second region and the second field; and
the mode prediction is an inter-mode prediction based on a reference from an un-refreshed region.
